(19) United States
(12) Patent Application Publication
(10) Pub. No.: US 2012/0289098 A1
(43) Pub. Date: Nov. 15, 2012

(54) CONNECTOR WITH CLAMPING MEANS

(75) Inventors: Karlo Stjepanovic, Bielefeld (DE); Michael Herrmann, Detmold (DE); Constantin Classen, Detmold (DE); Dietmar Horn, Blomberg (DE); Juergen Ziemke, Detmold (DE); Walter Hanning, Detmold (DE)

(73) Assignee: WEIDMUELLER INTERFACE GMBH & CO. KG, Detmold (DE)

(21) Appl. No.: 13/406,591

(22) Filed: Feb. 28, 2012

(30) Foreign Application Priority Data
May 13, 2011 (DE) 20 2011 050 120.5

(51) Int. Cl. H01R 4/48

(52) U.S. Cl. 439/822

(57) ABSTRACT

An electrical connector for connecting to a bus bar the bare end of an insulated conductor, including a rectangular housing containing an open-topped chamber, a conductive L-shaped bus bar arranged in the chamber with a vertical leg thereof extending adjacent one housing end wall, a generally planar clamping bar having a first end portion pivotally connected with the housing adjacent another end wall thereof for pivotal movement about a horizontal pivot axis, and a spring arranged in the housing chamber for biasing the clamping bar upwardly in the housing, whereby when the conductor bare end is inserted downwardly into the housing, the free edge of the clamping bar clamps the conductor bare end into contiguous engagement with the bus bar vertical leg portion. The spring is preferably a leaf spring having a Z-shaped or U-shaped configuration.

### BACKGROUND OF THE INVENTION

1. Field of the Invention

An electrical connector for connecting to a bus bar the bare end of an insulated conductor, including a rectangular housing containing an open-topped chamber, a conductive L-shaped bus. bar arranged in the chamber with a vertical leg thereof extending adjacent one housing end wall, a generally planar clamping bar having a first end portion pivotally connected with the housing adjacent another end wall thereof for pivotal displacement about a horizontal pivot axis, and a spring arranged in the housing chamber for biasing the clamping bar upwardly in the housing, whereby when the conductor bare end is inserted downwardly into the housing, the free edge of the clamping bar clamps the conductor bare end into contiguous engagement with the bus bar vertical leg portion.

2. Description of Related Art

It is known in the patented prior art to provide electrical connectors including spring-biased clamping means for biasing a conductor toward locked engagement with a bus bar, as shown, for example, by the patents to. Beege et al U.S. Pat. No. 6,280,233, Fricke et al U.S. Pat. No. 6,796,855, Drewes et al U.S. Pat. No. 6,893,286, and Holterhoff et al U.S. Pat. No. 7,287,999, among others.

Various types of clamping means are used in connection with devices for connection or contacting of an electrical conductor. In a clamping position, a properly insulated or bare electrical conductor with a bus bar is moved into an electrically conducting connection via a clamping point of a clamping element by means of spring force. For this purpose, the conductor bare end that is to be connected is inserted into the connection device. The connection device can be opened by an actuation unit so that the conductor may be easily inserted and also extracted.

In the field of these connection devices and clamping units, there is a constant requirement for optimizing the structural space requirement coupled with low product costs mid a high degree of contacting safety.

The present invention was developed to create an improved clamping unit and an improved corrector arrangement.

### SUMMARY OF THE INVENTION

Accordingly, a primary object of the present invention is to provide an electrical connector for connecting to a bus bar the bare end of an insulated conductor, including a rectangular housing containing an open-topped chamber, a conductive L-shaped bus bar arranged in the chamber with a vertical leg thereof extending adjacent one housing end wall, a generally planar clamping bar having a first end portion pivotally connected with the housing adjacent another end wall thereof for pivotal displacement about a horizontal pivot axis, and a spring arranged in the housing chamber for biasing the clamping bar upwardly in the housing. Thus, when the conductor bare end is inserted downwardly into the housing chamber, the free edge of the clamping bar clamps the conductor bare end into contiguous electrical engagement with the bus bar vertical leg portion.

According to another object of the invention, the spring biasing means comprises a leaf spring having a configuration that is Z-shaped, L-shaped, or U-shaped. The leaf spring includes a linear end portion that is pivotally connected with the housing end wall to which the clamping bar is pivotally connected. Alternatively, this leaf spring linear end portion may be secured in contiguous surface-to-surface contact with the bottom surface of the clamping bar. The length of the clamping bar is greater than the spacing distance between the end walls, whereby when the clamping bar is biased upwardly toward the released position, it is slightly downwardly inclined with the free extremity thereof in engagement with the bus bar vertical leg portion.

The clamping means of the connector combines the advantages of a so-called push-in clamping spring with a small structural width plus good contacting security, in that at least one supplementary spring element is arranged inside the defined interior space of the housing on the side of the clamping bar facing away from the conductor insertion side. In the prior art devices, on the other hand, the clamping bar itself is made elastic in a V-shaped manner. In contrast to this state of the art, the . present invention—as related to the particular conductor cross-section—provides a structural shape that is smaller, in particular, that is “shorter” in an x-direction normal to the conductor insertion direction (“z” in FIG. 2), as will be explained in further detail below with reference to FIG. 16.

In a preferred embodiment, the clamping bar is arranged in the housing chamber and includes a pivot segment that extends into a pivot opening contained in the housing end wall opposite the clamping point. This results in a simple structure. The housing can be formed by punching and bending from a metal sheet, whereby a recess can be punched to define the pivot axis in a simple manner. Besides, this facilitates simple assembly by merely inserting the clamping bar projection into the pivot opening.

The spring element can in each case be in contact with the clamping bar and with the cage, at least segment by segment. In other words, the spring element can have a surface that rests against the underside of the clamping bar. This resting position, however, can also be a contact line or a contact point. Besides, this resting position can be in the same or essentially the same position in each pivot position of the clamping bar, or it can change the position, that is to say, the segment of the spring element and of the clamping bars can move or shift with relation to each other. In another embodiment, the spring element can have a pivot segment by means of which it is pivotally attached in the front wall of the housing. For example, the same recess in the front wall can serve to receive the pivot segment of the clamping bar as well as the spring element.

In an alternate embodiment, the spring element can be made integral with the clamping bar, which facilitates a partial reduction. In one particular embodiment, the spring element can have a Z-shaped configuration with a straight spring pressure segment and a support segment that is essentially parallel thereto, which via a straight connection segment are connected in each case by an arc segment.

According to a further embodiment, the spring element can be L-shaped with a straight spring pressure segment and a connection segment that is essentially perpendicular thereto, which via two opposite arc segments is attached to the spring pressure segment.

In another embodiment, the spring element has a widened U-shaped configuration with a short spring pressure segment, which via an arc segment is attached on one end of a straight connection segment, which via another arc segment is connected with a straight support segment. This straight support segment can extend parallel to the foot segment of the bus bar and can rest on the foot segment of the bus bar. This results in a structure that can be useful for simple assembly. In another embodiment, the bus bar can be made without a foot segment, whereby, for example, a segment of the cage on the underside of at least one side wall serves as a thrust bearing for the straight support segment. It is furthermore possible that the housing might display only one side wall.

In yet another alternate embodiment, the spring element can have a widened U-shaped configuration with a short spring pressure segment, which via an arc segment is attached on one end of a bent connection segment, which via another arc segment is connected with a straight support segment. Here, the bent connection segment can have a rather essentially larger arc radius than that of the arc segments, whereby one arc segment can have a smaller arc radius than the other arc segment.

Furthermore, in another embodiment, the wider arc segment can rest upon the foot segment of the bus bar, whereby the straight support segment can extend along the front wall of the housing and can rest on the front wall. In this way, one makes use of the interior space and walls of the housing.

The various embodiments of the spring element can, if the housing and the clamping bar have the same shape, make it possible to use the clamping unit in a vast area. This facilitates an adaptation to differing clamping housing by means of the simple insertion of differing spring elements during assembly.

The connector includes a housing to receive a clamping unit, a bus bar and an insertion opening for the introduction of the electrical conductor into the clamping unit, preferably into the housing; a pivotable e clamping bar for the clamping and contacting of the electrical conductor on the bus bar, preferably arranged in the housing, and at least one spring element for the exercise of a force upon the clamping bar, whereby the clamping unit is made as a clamping unit as described above.

### BRIEF DESCRIPTION OF THE DRAWINGS

Other objects and advantages of the invention will become apparent from a study of the following specification, when viewed in the light of the accompanying drawing, in which:

FIGS. 1 and 2 are perspective and side elevation views, respectively, of a first embodiment of the electrical connector of the present invention, with the clamping bar being in the released position;

FIG. 3 is a perspective view corresponding to FIG. 1 with the housing removed;

FIG. 4 illustrated the connector with the bare end of a conductor being placed for downward insertion into the housing chamber, and FIGS. 5 and 6 are side elevation and perspective view of the apparatus with the conductor bare end inserted and clamped within the housing chamber;

FIGS. 7 and 8 are perspective views of a second embodiment of the invention with and without the housing, respectively, and FIGS. 9 and 10 are partially-exploded side elevation views of the apparatus of FIG. 7 prior to and during the insertion of the bare conductor end into the housing chamber;

FIG. 11 is a side elevation view of a modification of the apparatus of FIG. 10;

FIGS. 12 and 13 are partially-exploded side elevation views of a third embodiment of the invention prior to and during the downward insertion of a conductor bare end into the housing chamber;

FIGS. 14 and 15 are side elevation views of a fourth embodiment of the invention prior to and during the downward insertion of a conductor bare end into the housing chamber; and

FIG. 16 is a diagrammatic representation comparing the present invention with a connector construction of the prior art.

### DETAILED DESCRIPTION OF THE INVENTION

Coordinate systems are illustrated in the figures, wherein x indicates the width direction, y indicates the depth direction, and z indicates the height direction.

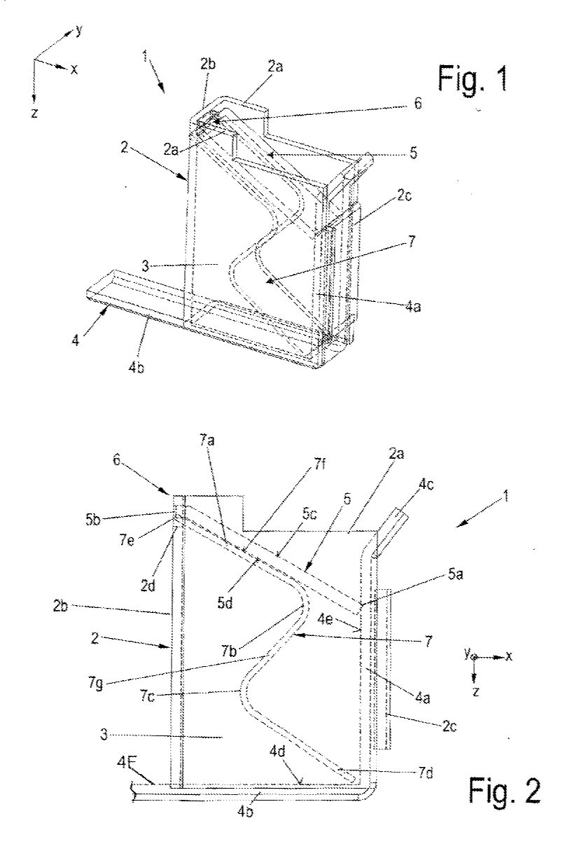

Referring first more particularly to FIGS. 1-3, the electrical connector is shown in the released condition, including an open topped rectangular housing 2 having a pair of vertical side walls 2a, a pair of vertical end walls 2b and 2c which walls cooperate to define a chamber 3.

The term “released condition” refers to the position (FIGS. 1-4) in which, in connector unit 1, no conductor is inserted and clamped within the housing chamber 3. The term “clamping position,” on the other hand, refers to the position in which a conductor is inserted into and clamped in the housing chamber (i.e., in FIGS. 5 and 6).

Connector unit 1 comprises a housing or cage 2, an L-shaped bus bar 4, a linear clamping bar 5, and a leaf spring element 7. The bus bar could also be made integrally with the housing (it could be one of the walls of the housing), if that housing, for example, were to be formed from a well-conducting material (not shown here).

Housing 2 has two side walls 2a that lie parallel and opposite each other in x-z planes, which on one side (in FIGS. 1 and 2) are connected by a front end wall 2b in the y-z plane. On the opposite side, the side walls 2a are partially connected in the y-z plane in a middle sector or about ⅔ with a retaining wall 2c. The two side walls 2a on their top sides in the x-direction are about ¾ lower in terms of their length in the x-direction with relation to a sector on the top side of the front wall 2b in the z-direction where they are about 1/10 lower than this sector.

In an modification (not shown), housing 2 has only one side wall 2a, with a front end wall 2b and the retaining end wall 2c.

In its upper sector, front wall 2b is provided with a recess 2d, which in this case is rectangular and which extends through the front wall 2b in the x-direction and in the y-direction. The function of recess 2b will be explained further below.

With its side walls 2a, its front end wall 2b, the retaining wall 2c, and a bottom wall 2e, housing 2 contains an interior chamber 3.

Housing 2 can be a metallic punched and bent component, or an injection-molded part consisting of a synthetic plastic material. Other embodiments are naturally possible. It is also conceivable that a synthetic substance clamping support might act as a housing 2 if it has corresponding contours/walls.

Bus bar 4 is L-shaped and includes a vertical contact leg portion 4a adjacent the inner surface of end wall 2c, and a horizontal connector leg portion 4b arranged adjacent the housing bottom wall 2e. The horizontal leg portion has an end extremity 4f that extends outwardly from the housing chamber in the x direction for connection with an electrical conductor or the like.

In another embodiment, not shown, bus bar 4 does not have a foot segment 4b. In this case, on the lower point of at least one side wall 2a in place of the foot segment 4b of bus bar 4, there is attached a foot segment that is connected with the side wall, for example, it may be handed over or it may be molded on.

Arranged inside the upper portion of chamber 3 is a clamping bar 5 that is pivotally connected at one end with the housing for pivotal movement about a horizontal pivot axis 6. More particularly, the clamping bar includes an end projection 5b that extends into a pivot opening 2d contained in the upper end of the housing wall 2b. The length of the clamping bar 5 is greater than the spacing distance between the housing end walls 2b and 2c, whereby when the clamping bar is in the illustrated downwardly inclined released position, the clamping edge 5a at the free end of the clamping bar engages the inner surface 4e of the bus bar vertical leg 4a: Clamping bar 5 has an upper surface 5c that is downwardly inclined when the clamping bar is in the illustrated released position. The engagement of clamping edge 5a with the contact surface 4e of bus bar 4 constitutes a stop and limits the pivotal movement of the clamping bar in the counterclockwise direction.

Arranged in chamber 3 below the clamping bar 5 is a generally Z-shaped leaf spring 7 that biases the clamping bar upwardly toward the released position of FIGS. 1-4. At it upper end, the spring has a projection portion 7e that extends into the pivot opening 2d below the clamping bar pivot projection 5b.

The linear spring pressure segment 7a extends below clamping bar 5 parallel to the latter over about ⅔ of its length and then runs into an adjoining arc segment 7b. Arc segment 7b has an opening angle between the spring pressure segment 7 and a connection segment 7g amounting to less than 90° in the clockwise direction and is connected with another arc segment 7c via a straight connection segment 7g. In this first exemplary embodiment, connection segment 7g is about ¾ the length of the spring pressure segment. The other arc segment 7c runs in opposition to the arc segment 7b with a similar opening angle between the connection segment 7g and a support segment 7d and transitions into a straight support segment 7b whose end rests on a support surface 4d of foot segment 4b of bus bar 4 near the transition of foot segment 4b into the contact segment. In the resting position, support segment 7d extends almost parallel to the spring pressure segment 7a.

With its upward-pointing surface acting as pressure segment 7f, the spring pressure segment 7a rests on the lower surface of bus bar 4, which is referred to as pressure segment 5d.

Spring element 7 is exposed to a certain prestress force by means of which clamping bar 5 with its clamping point is pressed in the opposite z-direction against the contact segment 4a in the clamping point.

Spring element 7 is arranged in the interior chamber 3 within a sector that is bordered by clamping bar 5, contact segment 4a, and the foot segment 4b of bus bar 4 as well as front wall 2b and the corresponding areas of side walls 2a of housing 2.

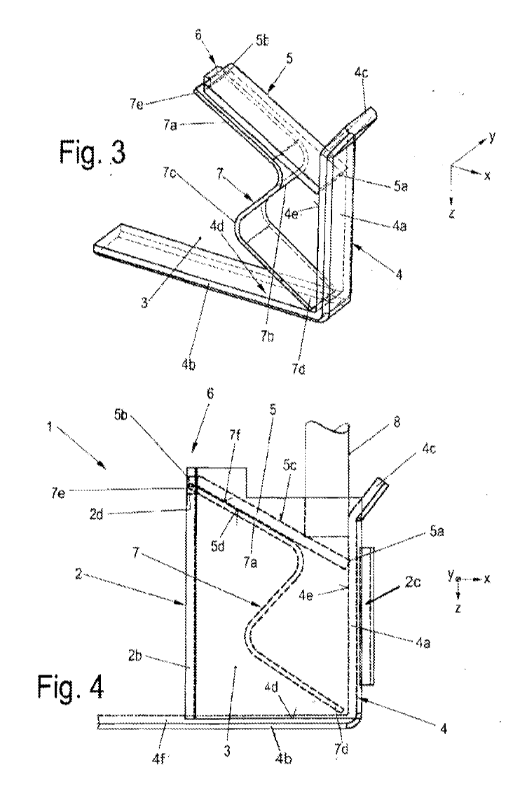

FIG. 3 shows a diagrammatic perspective view of the first exemplary embodiment according to FIG. 1 without the housing 2. It will be seen that the pivot portion 5b of clamping bar 5 is arranged in the y-direction centrally on the end of clamping bar 5 and takes up about half the length of the clamping bar 5 in the y-direction. Swing segment 7e or spring element 7 can also have a similar shape.

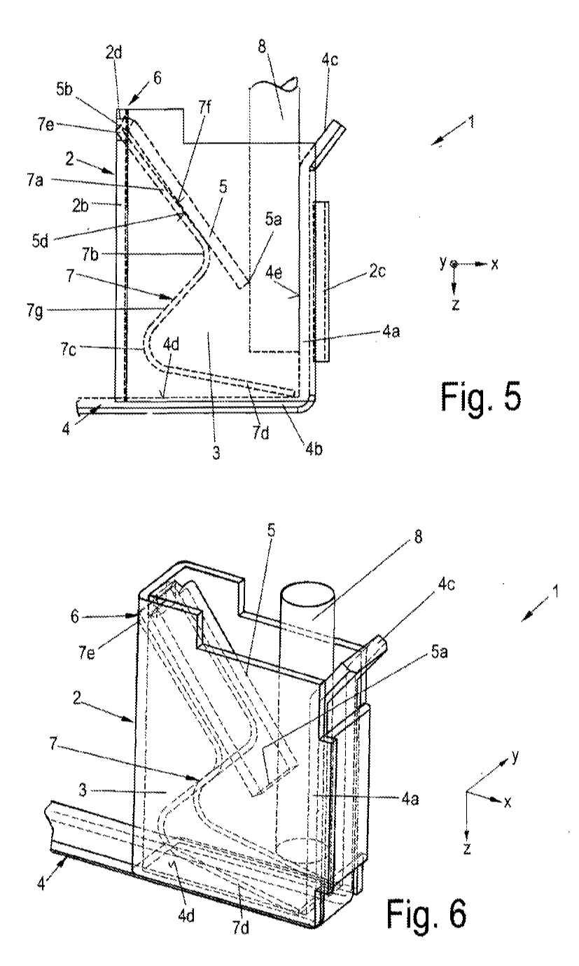

FIG. 4 shows a diagrammatic side view of the first exemplary embodiment according to FIG. 2 prior to the introduction of the bare end of an insulated conductor 8. The connector 1 is still in the released condition. Conductor 8 is introduced downwardly in an insertion direction that runs in the z-direction first of all between the outwardly gent insertion guide portion 4c of the bus bar, which facilitates the introduction of conductor 8, and then the clamping edge 5a of bus bar 4 and the top 5c of clamping bar 5. In the process, the lower end of conductor 8 presses on the top 5c of clamping bar 5, whereby the latter, as a result of an increase in this pressure (or by a tool or actuator not shown) swings around the swing axis 6 in the clockwise direction against the spring force of spring element 7 into the interior chamber 3. As conductor 8 is inserted into connector 1, spring element 7 is stressed via the clamping bar 5.

The introduced and clamped conductor 8 in the clamping point of clamping unit 1 is illustrated by FIG. 5 in a diagrammatic side view and by FIG. 6 in a diagrammatic perspective view of the first exemplary embodiment according to FIG. 1.

In the clamping condition, conductor 8 is biased toward the contact surface 4e of bus bar 4 and is clamped against the bus bar by the clamping edge 5a of clamping bar 5, owing to the spring force of spring element 7. Clamping bar 5 is pivoted around the pivot axis 6, just as the spring pressure segment 7a of spring element 7. Arc segment 7b of spring element 7 is widened in the clamping condition, that is to say, the opening angle between the spring pressure segment 7a and the connection segment 7g is greater than 90°. At the same time, the other arc segment 7c is further bent together, whereby the opening angle between connection segment 7g and support segment 7d is less than 90°. As a result, spring element 7 is under a greater pre-stress force than in the released position.

Clamping edge 5a of clamping bar 5 not only has the function of pressing conductor 8 against contact surface 4e, but also acts in the direction of extraction (opposite to the z-direction) of conductor 8 in such a manner that the extraction of conductor 8 out of clamping unit 1 is blocked, whereby the clamping effect is increased. This kind of self-inhibition is brought about by the swing axis 6 positioned on top and by the clamping edge 5a, which is in a lower position in that respect. The self-inhibition is enlarged by the pivot axis 6, which is in a higher position to the lower positioned clamping edge 5a due to the greater length of the front wall 2b of cage 2 in the z-direction opposite the unlatched side walls 2a. As a result, lever arms acting in the self-inhibition position in clamping bar 5 between the force introduction sector of the spring force of spring element 7 and the swing axis 6 as well as between the swing axis 6 and clamping edge 5a become as large as possible.

As shown in FIG. 5, in the clamping condition only a small segment of the spring pressure segment 7f of spring element 7 in the transition to arc segment 7b is in contact with the pressure segment 5d of clamping bar 5 in a narrow force introduction sector.

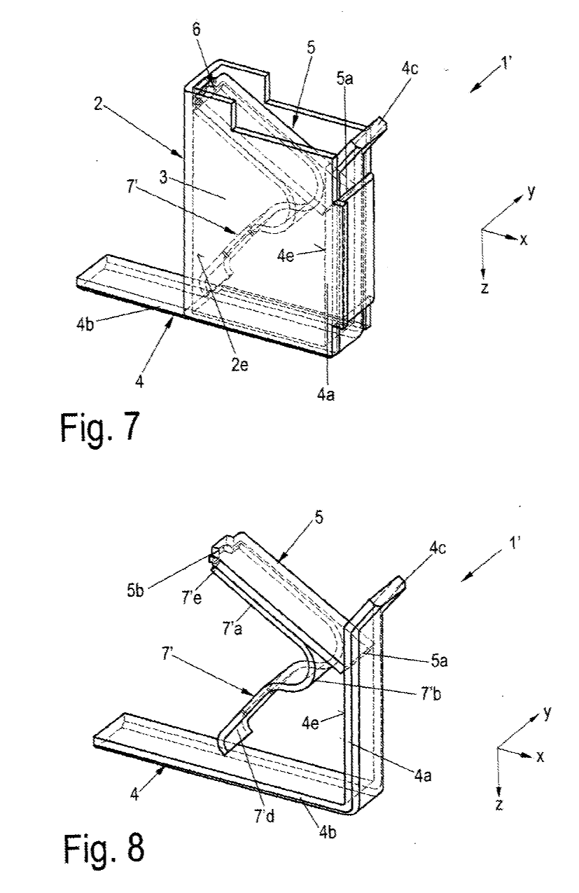

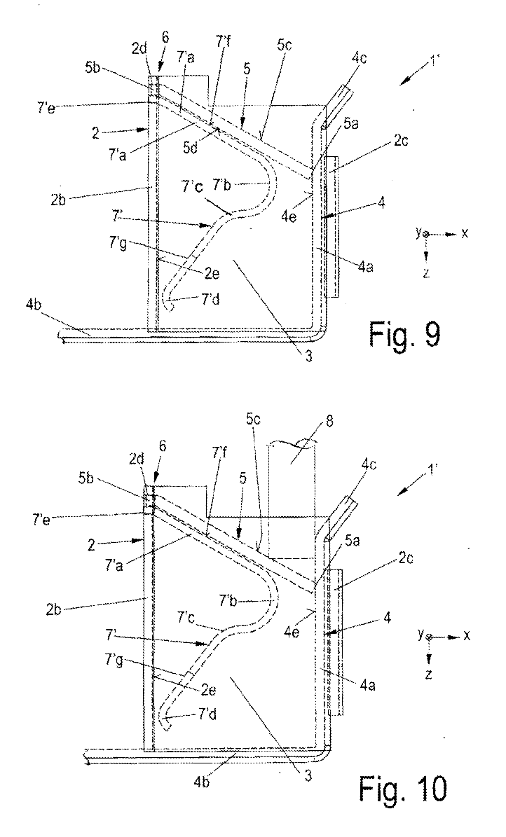

FIGS. 7 and 8 show diagrammatic perspective views of a second exemplary embodiment of the inventive clamping unit 1′ in the released position. Housing 2 is omitted in FIG. 8. FIG. 9 shows a diagrammatic side view of the second exemplary embodiment according to FIG. 7.

The second exemplary embodiment differs from the first one by the structure of spring element 7′, which in this case in the resting position has a reverse L-shaped configuration and is arranged in the interior space 3 below clamping bar 5.

Spring element 7′ also has a spring pressure segment 7′a whose one end is shaped as pivot segment 7′e for insertion into the recess 2d of the front wall 2b, and, as in the first embodiment, is received below clamping bar pivot segment 5b in recess 2d. Spring segment 7′a forms the short leg of the L-shaped configuration of spring element 7′ and in the resting position with its pressure segment 7′f rests against pressure segment 5d of the underside of clamping bar 5 (FIG. 9).

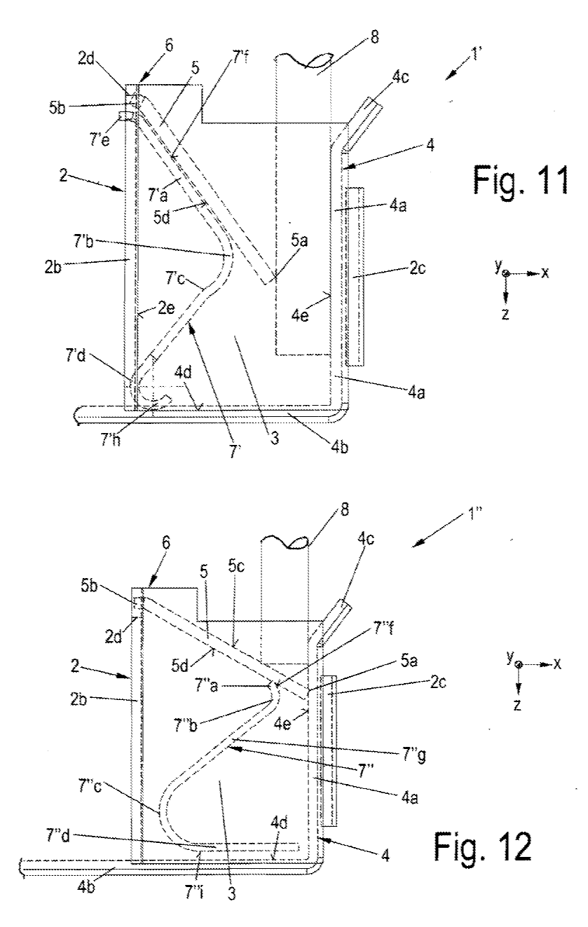

The other end of spring pressure segment 7′a transitions into arc segment 7′b, which has an opening angle of about 180° and which extends in the clockwise direction into the interior chamber 3. The other end of arc segment 7′b is connected with another arc segment 7′c that which runs counter to arc segment 7′b, which runs in an arched manner against the clockwise direction and which has an opening angle of about 45°. Its other end is connected with a straight connection segment 7′g essentially at a right angle and thus extends perpendicularly to the spring pressure segment 7′a (and thus also with respect to clamping bar 5 in that resting position) and which on its other end transitions into an arc-shaped support segment 7′d with an opening angle of about 90° bent against the clockwise direction. This arc-shaped support segment 7′d in the released position rests against the inside surface 2e of front wall 2b of housing 2. (For purpose of illustration, the end portion 7′d is shown in FIGS. 10 and 11 as being spaced from the end wall inner surface 2e.)

In the released position of this second exemplary embodiment, clamping edge 5a also, as in the first exemplary embodiment, rests against clamping surface 4e of contact segment 4a of bus bar 4.

FIG. 10 shows a diagrammatic side view of the second exemplary embodiment according to FIG. 7 prior to the introduction of the bare end of conductor 8, and FIG. 11 represents a diagrammatic view of the second exemplary embodiment according to FIG. 7 in the clamping position with conductor 8 inserted into the chamber 3.

The insertion of the properly insulated end of conductor 8 takes place as described in the first exemplary embodiment. Spring element 7′ is stressed in that the support segment 7′d is supported against the inside surface 2e or recess 2d of housing 2. At the same time, arc segments 7′b and 7′c are widened and generate the spring force that acts upon the clamping bar 5 to clamp conductor 8 via clamping edge 5a against clamping surface 4e of contact segment 4a of bus bar 4. FIG. 11 shows a modification of spring element 7′, whereby the arc-shaped support segment 7′d transitions into another terminal arc segment 7′h that engages the upper surface 4d of bus bar horizontal leg 4b. The arc-shaped support segment 7′d and the additional terminal arc segment 7′h have the same opening angle, that is to say, they have a common opening angle of about 180° and radii with a common center that is indicated by the dot-dash cross.

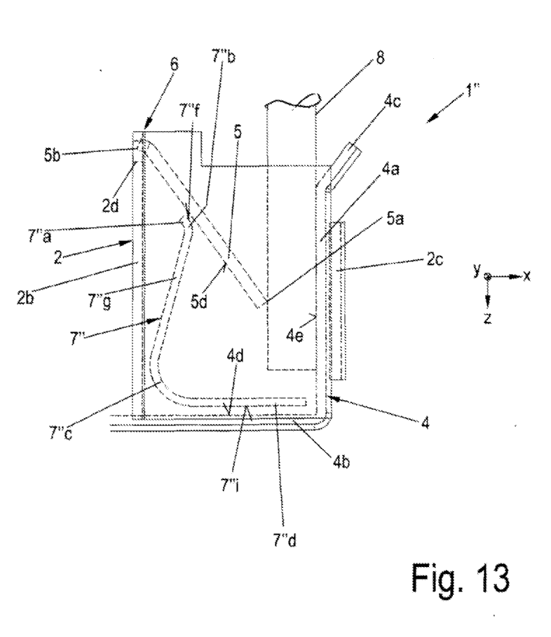

FIGS. 12 and 13 show a third exemplary embodiment of the inventive connector 1″ in each case by way of a diagrammatic side view prior to the introduction of a conductor and in the clamping point (FIG. 13).

The third exemplary embodiment also differs from the first and second by the structure of spring elements 7″. In the resting position, spring element 7″ has a widened U-shaped configuration and is also arranged in the interior space 3 below clamping bar 5. A spring pressure segment 7″a of spring element 7″ here is arranged very briefly on the end pointing toward front wall 2b of an arc segment 7″b with an opening angle of about 90°. Pressure segment 7″f is arranged on the side of spring pressure segment 7″a, which faces toward clamping bar 5 and of arc segment 7″b. Spring element 7″ does not have a pivot segment and does not extend in the recess 2d of front wall 2b. Only pivot segment 5b of clamping bar 5 is arranged in recess 2d in swing axis 6.

The other end of arc segment 7″b is a leg of the U-shaped configuration and is made as a straight connection segment 7″g. Connection segment 7″g runs at an angle of less than 90° with respect to clamping bar 5 toward left bottom or toward front wall 2b of cage 2 into the interior chamber 3 and transitions into another arc segment 7″c that runs at an arch bent against the clockwise direction and that has an opening angle between connection segment 7″g and the support segment 7″d amounting to less than 180°. Its other end is connected with a straight support segment 7″d that runs parallel to the foot segment 4b of bus bar 4 and that, with a lower support surface 7″i, rests on the support surface 4d of the foot segment 4b of bus bar 4. (For purpose of illustration, in FIGS. 12 and 13, the surfaces 4d and 7″i are shown as being slightly spaced.) The length of this support amounts to about ¾ of the length of the support surface 4d. Support segment 7″d of spring element 7″ constitutes the other leg of the U-shaped configuration of spring element 7″.

In the released position of this third exemplary embodiment, clamping edge 5a, as in the first and second exemplary embodiments, rest against clamping surface 4e of contact segment 4a of bus bar 4.

FIG. 13 shows a diagrammatic side view of the third exemplary embodiment according to FIG. 12 with the inserted conductor 8 in the clamping point of clamping unit 1″. The insulated end of conductor 8 is inserted as in the first and second exemplary embodiments. Spring element 7″ is stressed in that support segment 7″d is supported on the support surface 4e of foot segment 4b of bus bar 4, whereby the arc segment 7″c is made wider and generates the spring force which acts upon clamping bar 5 for the clamping of conductor 8 via the clamping edge 5a against clamping surface 4e of contact segment 4a of bus bar 4. In this widening of arc segment 7″c, the latter's opening angle of 180° is enlarged because the spring pressure segment 7″a and the arc segment 7″b on the underside of clamping bar 5 move toward its pressure segment 5d in the direction toward swing axis 6. A part of the external arc surface of the other arc segment 7″c can, in the transition to the connection segment 7″g, rest on the inside surface 2e of front wall 2b of housing 2.

Fig, 14 and 15 show a fourth exemplary embodiment of the inventive clamping unit 1′″ in each case by way of a diagrammatic side view in the resting position and in the clamping position (FIG. 15).

The fourth exemplary embodiment also differs from the first, second, and third by the structure of spring element 7′″. Spring element 7′″ in the released position also has a U-shaped configuration with a long straight leg and a shorter bent leg and also arranged in the interior space 3 below clamping bar 5. Spring pressure segment 7′″ a of spring element 7′″ here, similar to the third exemplary embodiment, is arranged on the front-wall-facing end 2b of an arc segment 7′″b with an opening angle of about 45°. The pressure segment 7′″f is arranged on the side of arc segment 7′″b, which faces toward clamping bar 5. This spring element 7′″ of the fourth exemplary embodiment also has a small spring segment and is not received in recess 2d of front wall 2b. Only swing segment 5b of clamping bar 5 is arranged in recess 2d in swing axis 6.

The other end of arc segment 7′″b is fashioned as an arc-shaped connection segment 7′″g with an essentially greater radius than that of arch segment 7′″b. Connection segment 7′″g runs toward left bottom to front wall 2b of cage 2 into interior space 3 and transitions into another arc segment 7′″c, which runs bent in the clockwise direction and which has an opening angle between the connection segment 7′″g and the support segment 7′″d amounting to less than 180°. Its other end is connected with the straight support segment 7′″d, which extends parallel to front wall 2b of cage 2 on the inside surface 2e of front wall 2b in the opposite z-direction, all the way over recess 2d, and which, with its support surface 7′″l, rests on the inside surface 2e of front wall 2b of cage 2. The length of this support amounts to about 9/10 of the length of front wall 2b.

In the released position of this fourth exemplary embodiment, clamping edge 5a, as in the case of the first, second, and third, exemplary embodiment, rests against the clamping surface 4e of contact segment 4a of bus bar 4.

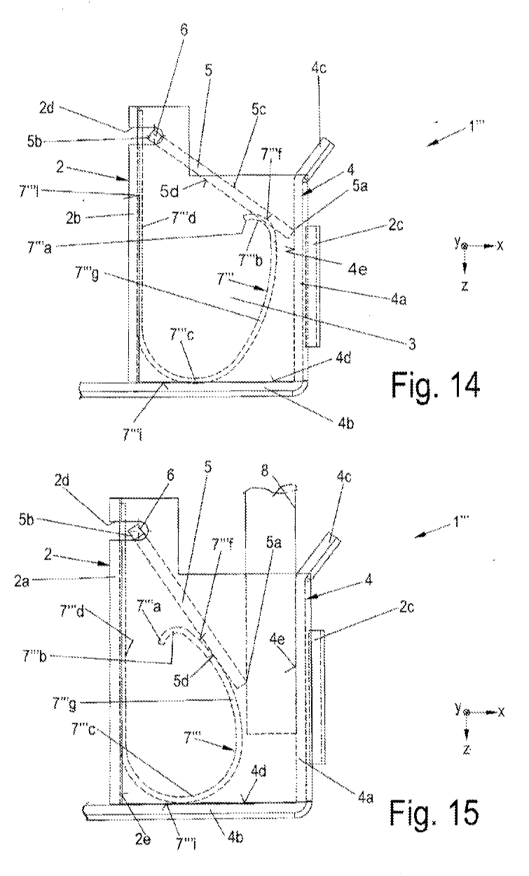

FIG. 15 shows a diagrammatic side view of the fourth exemplary embodiment according to FIG. 14 with the inserted conductor 8 in the clamping point of clamping unit 1′″. As in the first, second, and third exemplary embodiments, the insulated end of conductor 8 is inserted into connector 1′″. Spring element 7′″ is pressed upon insertion of conductor 8. In the process, spring pressure segment 7′″ a shifts along pressure segment 5d of the underside of clamping bar 5 in such a manner that spring pressure segment 7″″ a is bent inward toward front wall 2b into the interior space 3, whereby pressure segment 7′″f migrates from the side of spring pressure segment 9 that faces toward clamping bar 5 to the side of the bent connection segment 7′″g. Arc segment 7′″c furthermore is supported on the support surface 4d of foot segment 4b of bus bar 4 with a support surface 7′″I, whereby its opening angle becomes smaller, that is to say, arc segment 7′″c is bent together as spring element 7′″ is stressed. Support segment 7′″d remains with its support surface 7′″l on the inside surface 4e of front wall 2b of cage 2.

The bent-together arc segment 7′″c generates the spring force, which in this fourth exemplary embodiment via the bent connection segment 7′″g of spring element 7′″ acts upon clamping bar 5 to clamp conductor 8 via clamping edge 5a against the clamping surface 4e of contact segment 4a of bus bar 4.

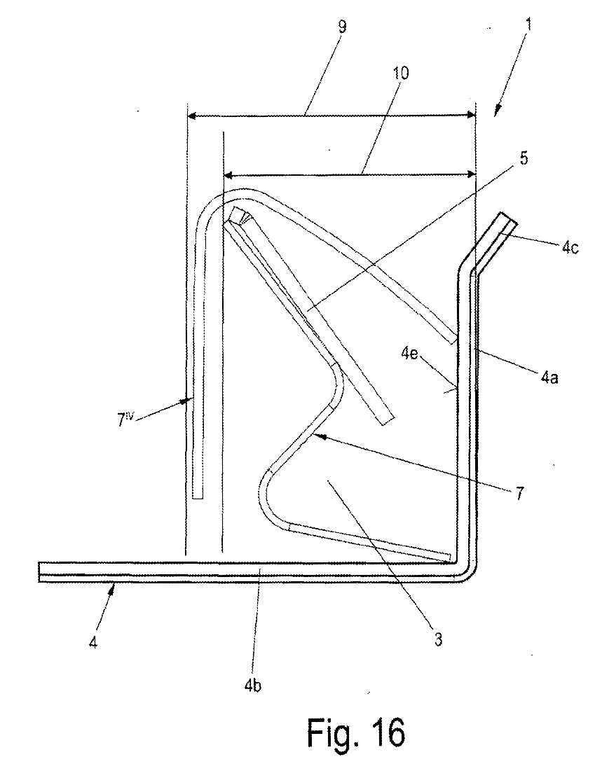

FIG. 16 shows a diagrammatic side view of the clamping points to explain the comparison to the state of the art.

A conventional embodiment of the clamping point displays a reverse V-shaped spring element 7^{IV}, whose one end is in a perpendicular position and is attached to the cage. The other end has a clamping point and presses against the contact surface 4e of contact segment 4a of the bus bar. Spring element 7′″ is arranged above interior space 3 and limits it toward the top. This requires a first horizontal dimension 9 from the attached leg of spring element 7^{IV} toward contact segment 4a.

In the inventive clamping device, spring element 7 is arranged inside interior chamber 3, whereby the latter is used in a manner that was not the case earlier. Besides, in that way, one can achieve a second horizontal dimension 10, which is smaller than the first horizontal dimension 7 in the conventional embodiment. We thus get a smaller dimension 10 in the x-direction with the same connection possibilities (spring element in the excursion state).

Clamping units 1, 1′, 1″, 1′″. can also be inserted into a corresponding housing made of synthetic material and can constitute a connection device not illustrated. This connection device can also have an actuation unit (not shown) by means of which, for example, with a tool, clamping bar 5 can be swung in order to insert conductor 8 or to loosen the clamped conductor S and to pull it out.

The above-explained exemplary embodiments do not restrict the invention. It is modifiable in the context of the attached claims. The connection device can be made as a series terminal. In the first, second, and third exemplary embodiments, it is also conceivable to make clamping bar 5 and spring element 7 integrally.

While in accordance with the provisions of the Patent Statutes the preferred forms and embodiments of the invention have been illustrated and described, it will be apparent to those skilled in the art that changes may be made without deviating from the invention described above.

What is claimed is:

1. An electrical connector for connecting the bare end of an insulated conductor (8) to a bus bar (4), comprising:
(a) a open-topped housing (2) having at least one vertical side wall (2a), and first (2b) and second (2c) vertical parallel spaced end walls arranged orthogonally relative to said side wall, said housing side and end walls cooperating to define a chamber (3);
(b) a conductive L-shaped bus bar (4) arranged in said chamber, said bus bar having a horizontal leg Portion (4b) extending across the bottom of said chamber, and a vertical leg portion (4a) extending upwardly from said horizontal leg portion adjacent the inner surface of said housing second end wall;
(c) a generally planar clamping bar (5) having a first end portion (5b) pivotally connected with said housing adjacent said first end wall for pivotal movement about a horizontal pivot axis (6), said clamping bar having a second end portion terminating in a clamping edge (5a); and
(d) spring means (7) arranged in said housing chamber below said clamping bar for biasing said clamping bar pivotally upwardly about said pivot axis, whereby when the conductor bare end is inserted downwardly into the chamber, the clamping bar edge clamps the bare conductor end laterally toward engagement with said bus bar vertical leg portion.

2. An electrical connector as defined in claim 1, wherein said bus bar vertical leg portion terminates at it upper end in an outwardly bent guide portion (4c).

3. An electrical connector as defined in claim 1, wherein said bus bar lower leg portion has a free end connecting portion (4e) that extends outwardly from said housing below said housing first end wall.

4. An electrical connector as defined in claim 3, wherein said bus bar horizontal leg portion defines the bottom of said chamber.

5. An electrical connector as defined in claim 1, wherein said housing first end wall contains adjacent its upper end a pivot opening (2d); and further wherein said clamping bar one end includes a pivot projection (5b) that extends into said pivot opening, thereby to define said horizontal pivot axis.

6. An electrical connector as defined in claim 5, wherein said spring means comprises a leaf spring (7; 7′) including a first end portion (7a; 7′a) having a pivot projection (7e; 7′e) that extends into said pivot opening below said clamping bar pivot projection.

7. An electrical connector as defined in claim 6, wherein said leaf spring first end portion is linear and contiguous with the lower surface of said clamping bar.

8. An electrical connector as defined in claim 7, wherein said leaf spring first end portion is fastened to said clamping bar.

9. An electrical connector as defined in claim 7, wherein said leaf spring is generally Z-shaped and includes a linear intermediate portion (7g) having a first end connected with the other end of said first end portion, and a linear second end portion (7d) connected with the other end of said intermediate portion.

10. An electrical connector as defined in claim 9, wherein said leaf spring second end portion terminates in an edge that is in engagement with the supper surface (4d) of said bus bar horizontal leg portion.

11. An electrical connector as defined in claim 7, wherein said leaf spring is generally L-shaped, and includes a second linear section (7′g) connected at one end with the other end of said first section, said second linear section terminating at its other end in a reversely-curved support portion (7′d) in engagement with said housing first end wall when said clamping bar is in said released position.

12. An electrical connector as defined in claim 11, wherein said leaf spring includes an auxiliary reversely-curved extension portion (7′h) connected with said support portion, said extension portion being in engagement with said bus bar horizontal leg portion.

13. An electrical connector as defined in claim 5, wherein said leaf spring has a widened generally U-shaped configuration including:
(1) a linear horizontal leg portion (7″d) in contiguous engagement with the upper surface (4d) of said bus bar horizontal leg portion;
(2) a curved connecting portion (7″c) adjacent said housing first end wall; and
(3) a linear upwardly-directed second leg portion (7″g) that terminates at its free end in a curved extremity (7″b) in engagement with the lower surface (5d) of said clamping bar.

14. An electrical connector as defined in claim 1, wherein said housing includes a pair of side walls containing opposed pivot openings (2e) adjacent the upper end of said first housing end wall; wherein said clamping bar one end includes a pair of lateral pivot projections (5b′) extending into said pivot openings, respectively, thereby to define said horizontal pivot axis; and further wherein said spring means comprises a generally U-shaped spring (7′″) having:
(1) a linear first leg portion (7′″d) extending upwardly in contiguous engagement with the inner surface of said housing first end wall;
(2) a curved connecting portion (7′″c) in engagement with the upper surface (4d) of said bus bar horizontal leg portion; and
(3) a curved second leg portion (7′″g) that terminates in an inwardly bent concave portion (7′″b) having an outer surface (7′′f) in engagement with the bottom surface (5d) of said clamping bar.

15. An electrical connector as defined in claim 1, wherein the length of said clamping bar is greater than the spacing distance between said housing first and second end walls, whereby prior to the insertion of the conductor bare end into said housing chamber, said clamping bar is normally spring-biased toward a slightly downwardly inclined released position with the clamping bar free edge in engagement with said bus bar vertical leg portion.
